(19) United States
(12) Patent Application Publication
(10) Pub. No.: US 2026/0291622 A1
(43) Pub. Date: Sep. 24, 2026

(54) Optical Communication System And Reset Method

(71) Applicant: NIPPON TELEGRAPH AND TELEPHONE CORPORATION, Tokyo (JP)

(72) Inventors: Hiroshi WATANABE, Musashino-shi, Tokyo (JP); Saki NOZOE, Musashino-shi, Tokyo (JP); Ryo KOYAMA, Musashino-shi, Tokyo (JP); Tomohiro KAWANO, Musashino-shi, Tokyo (JP); Kazuhide NAKAE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/874,055

(22) PCT Filed: Jun. 16, 2022
(86) PCT No.: PCT/JP2022/024207

§ 371 Date: Dec. 11, 2024

(51) Int. Cl. H04B 10/80; H04B 10/077; H04B 10/25; H04B 10/272

(52) U.S. Cl. CPC H04B 10/807; H04B 10/0773; H04B 10/25; H04B 10/272

(57) ABSTRACT

An object of the present invention is to provide an optical communication system that can reduce costs and improve the operation of an optical fiber network.

In an optical communication system 301 according to the present invention, power supply light is supplied from a parent node 10 to a child node 20 through an optical fiber 52, the parent node 10 superimposes a signal on the power supply light and transmits a reset signal to one child node 20 through the optical fiber 52, the child node 20 receives the reset signal from the optical fiber 52 to reset itself, the parent node 10 superimposes a signal on the power supply light and transmits a reset completion confirmation signal to the child node 20 through the optical fiber 52, the child node 20 intensity-modulates the power supply light supplied from the parent node 10 to generate a response signal, and transmits the response signal to the parent node 10 through the optical fiber 52 after resetting itself and after receiving the reset completion confirmation signal, and the parent node 10 determines success or failure of resetting the child node 20 based on the presence or absence of the response signal transmitted from the child node 20 through the optical fiber 52.

### TECHNICAL FIELD

The present disclosure relates to an optical communication system configured with optical nodes that are optically powered, and a reset method for remotely resetting the optical nodes.

### BACKGROUND ART

In optical fiber networks, especially access networks that connect communication devices installed in communication buildings and communication terminals on the user side, in order to efficiently use equipment during the opening and maintenance of the optical fiber networks, switching of optical fiber core wires, such as installing a new route or changing to a different route, is performed at a certain frequency. Normally, such core wire switching work requires a worker to go to the site and manually switch the connections of the optical fiber core wires, but a technology has been proposed in which the connections of the optical fiber core wires are switched by remote control.

For example, NPL 1 and 2 disclose methods in which, in a system including a power supply control light source installed in a power supply environment such as in a laboratory, and one or more optical nodes located remotely, a single laser can simultaneously implement the functions of optical power supply and control of a plurality of optical switches included in the optical node. This optical node is installed in an optical fiber network, and connects and switches core wires of optical fibers for communication/main signals on a core wire-by-core wire basis.

FIG. 1 is a diagram illustrating a configuration in which optical power is supplied to optical nodes of an optical fiber network in a parallel manner. Optical power supply light emitted from a power supply control light source 11 located inside an optical node (hereinafter, the optical node is referred to as a “parent node”) installed inside a communication building or the like is transmitted to a plurality of optical nodes (hereinafter, the optical nodes are referred to as “child nodes) through one of a plurality of optical fibers 52 for power supply by a channel selector (optical switching device) 12 located inside or near the parent node 10. The power supply light is photoelectrically converted by an optical power supply converter 21 of the child node 20, and is stored as electric power in a power storage unit 22.

Furthermore, a control signal generated by intensity modulation or the like is superimposed on the optical power supply light. This control signal is, for example, a serial communication system. Using the control signal received by the child node 20, devices such as a peripheral interface controller (PIC) microcomputer 23 in the child node 20 are operated. Further, a control signal may be sent back from the child node 20 side to the parent node 10 as necessary. Note that, since this child node 20 is installed outdoors in a wide range of locations, it does not use a commercial power source and is operated using optical power supplied from the parent node 10.

FIG. 2 is a diagram illustrating a configuration in which optical power is supplied to optical nodes of an optical fiber network in a serial manner. Optical power supply light emitted from the power supply control light source 11 located in the parent node 10 in a communication building or the like is sequentially transmitted to the plurality of child nodes 20 through a single optical fiber for power supply. Each child node 10 is equipped with a 1×2 optical switch (n×n optical switch) 24, and switches the direction of supplying the optical power supply light to the optical power supply converter 21 within its own child node 20 or sending it to the rear child node 20. This 1×2 optical switch 24 is switched by a control signal superimposed on the optical power supply light. In this way, the 1×2 optical switch 24 switches, using the control signal, the route of the optical core wire that allows the power supply control light source 11 and each child node 20 to communicate one-on-one in a time-division manner.

When a voltage value stored in the power storage unit 22 becomes equal to or lower than a predetermined voltage value, the PIC microcomputer 23 and the optical switch 24 cannot be controlled or driven. Therefore, when a plurality of child nodes 20 exist as in the configurations shown in FIGS. 1 and 2, the prerequisite for operation is that optical power is supplied by appropriately switching the channel selector 12 or each 1×2 optical switch 24, and that a constant amount of power is always maintained to be stored in each power storage unit 22.

In order to always maintain a constant amount of stored power in the power storage unit 22 of each child node 20, the power supply control light source 11 may inquire and check the amount of power stored in the power storage unit 22 from the child node 20 at any time using a control signal.

### CITATION LIST

### Non Patent Literature

[NPL 1] 2021 Institute of Electronics, Information and Communication Engineers General Conference B-13-16, “Study on remote operated optical fiber switching node for future access network”

[NPL 2] 2022 Institute of Electronics, Information and Communication Engineers General Conference B-13-28, “Study on number of remote operated optical fiber switching nodes aligned in a line”

### SUMMARY OF INVENTION

### Technical Problem

In an optical fiber network configured with the above-mentioned optical nodes, it may be necessary to restart (reset) the child nodes. For example, there are cases where new firmware is installed by some means in a PIC microcomputer mounted on a child node, and the old firmware is changed to the new firmware. In such a case, a worker needs to go to the site and reset each child node. However, the worker going to the site and resetting each child node has a problem in that it is difficult to reduce costs and improve the operation of the optical fiber network.

Therefore, in order to solve the above problem, an object of the present invention is to provide an optical communication system and a reset method that can reduce costs and improve the operation of an optical fiber network.

### Solution to Problem

In order to achieve the above object, an optical communication system according to the present invention has a configuration in which a child node can be remotely reset from a parent node side and whether the remote reset is successful or unsuccessful can also be confirmed.

Specifically, an optical communication system according to the present invention is an optical communication system in which one parent node and one or more child nodes are connected by an optical fiber for a main signal and an optical fiber for optical power supply, and light for driving power is supplied from the parent node to the child node through the optical fiber for optical power supply, in which
the parent node superimposes a signal on the light for driving power and transmits a reset signal and a reset completion confirmation signal to any one of the child nodes through the optical fiber for optical power supply, and the parent node determines success or failure of resetting the child node based on the presence or absence of a response signal transmitted from the child node through the optical fiber for optical power supply, and
the child node receives the reset signal from the optical fiber for optical power supply to reset the child node itself, and after resetting the child node itself and after receiving the reset completion confirmation signal, the child node superimposes a signal on the light for driving power supplied from the parent node to generate the response signal, and transmits the response signal to the parent node through the optical fiber for optical power supply.

Further, a reset method for resetting a child node according to the present invention is a reset method for resetting a child node in an optical communication system in which one parent node and one or more child nodes are connected by an optical fiber for a main signal and an optical fiber for optical power supply, and light for driving power is supplied from the parent node to the child node through the optical fiber for optical power supply, the reset method including: superimposing, by the parent node, a signal on the light for driving power and transmitting, by the parent node, a reset signal to any one of the child nodes through the optical fiber for optical power supply;
receiving, by the child node, the reset signal from the optical fiber for optical power supply to reset the child node itself;
transmitting, by the parent node, a reset completion confirmation signal through the optical fiber for optical power supply;
superimposing, by the child node, after resetting the child node itself and after receiving the reset completion confirmation signal, a signal on the light for driving power supplied from the parent node to generate a response signal, and transmitting, by the child node, the response signal to the parent node through the optical fiber for optical power supply; and
determining, by the parent node, success or failure of resetting the child node based on the presence or absence of the response signal transmitted from the child node through the optical fiber for optical power supply.

With the present optical communication system and reset method, since it is possible to remotely reset a child node from a parent node side and it is also possible to confirm whether the remote reset is successful or unsuccessful, there is no need for workers to go to the site. Therefore, the cost and time of dispatching workers to the site can be saved.

Therefore, the present invention can provide an optical communication system and a reset method that can reduce costs and improve the operation of an optical fiber network.

The child node is powered and controlled by optical power supply light from a single power supply control light source from the parent node. Since the amount of power stored in child nodes that are not optically powered decreases, it is necessary to efficiently optically supply power to a plurality of child nodes.

Thus, in the optical communication system according to the present invention, until the parent node transmits the reset completion confirmation signal after transmitting the reset signal to any one of the child nodes, the light for driving power is supplied to any of the child nodes other than the corresponding child node. The efficiency of optical power supply can be improved by storing power in other child nodes using the reset time.

In the optical communication system according to the present invention, it is preferable that the parent node transmit the reset signal and the reset completion confirmation signal a prescribed number of times when the response signal is not received after transmitting the reset completion confirmation signal. Even if resetting a child node fails, the reset may succeed after retrying. By automatically repeating reset retries, it is possible to reduce the number of man-hours for workers and reduce costs.

In the optical communication system according to the present invention, it is preferable that the child node include, in the response signal, a start time at which the reset is started and a completion time at which the reset is completed, and the parent node extract the start time and the completion time from the response signal, and manage the start time and the completion time for each child node. By ascertaining the time required for resetting each child node at the parent node, it is possible to appropriately set the timing for sending the reset completion confirmation signal. In other words, it is possible to avoid issuing the reset completion confirmation signal while the child node is being reset, and to avoid wasting time after the child node has completed resetting.

The above inventions can be combined whenever possible.

### Advantageous Effects of Invention

According to the configuration of the present invention, in an optical fiber network configured with optical nodes, it is possible to remotely restart a child node (remote reset), and it is also possible to confirm whether the remote reset is successful or unsuccessful. Therefore, a plurality of remote child nodes can be reset at once from a parent node without the need for workers to go to the site. Therefore, the present invention can provide an optical communication system and a reset method that can reduce costs and improve the operation of an optical fiber network.

### BRIEF DESCRIPTION OF DRAWINGS

FIG. 1 is a diagram illustrating a configuration in which optical power is supplied to optical nodes of an optical fiber network in a parallel manner.

FIG. 2 is a diagram illustrating a configuration in which optical power is supplied to optical nodes of an optical fiber network in a serial manner.

FIG. 3 is a diagram illustrating an optical communication system according to the present invention.

FIG. 4 is a diagram illustrating a reset method for an optical node according to the present invention.

FIG. 5 is a diagram illustrating an optical communication system according to the present invention.

FIG. 6 is a diagram illustrating a reset method for an optical node according to the present invention.

FIG. 7 is a diagram illustrating an optical communication system according to the present invention.

FIG. 8 is a diagram illustrating a reset method for an optical node according to the present invention.

FIG. 9 is a diagram illustrating an optical communication system according to the present invention.

### DESCRIPTION OF EMBODIMENTS

Embodiments of the present invention will be described with reference to the accompanying drawings. The embodiments described below are examples of the present invention, and the present invention is not limited to the following embodiments. Constituent elements with the same reference numerals in the present specification and the drawings represent the same constituent elements.

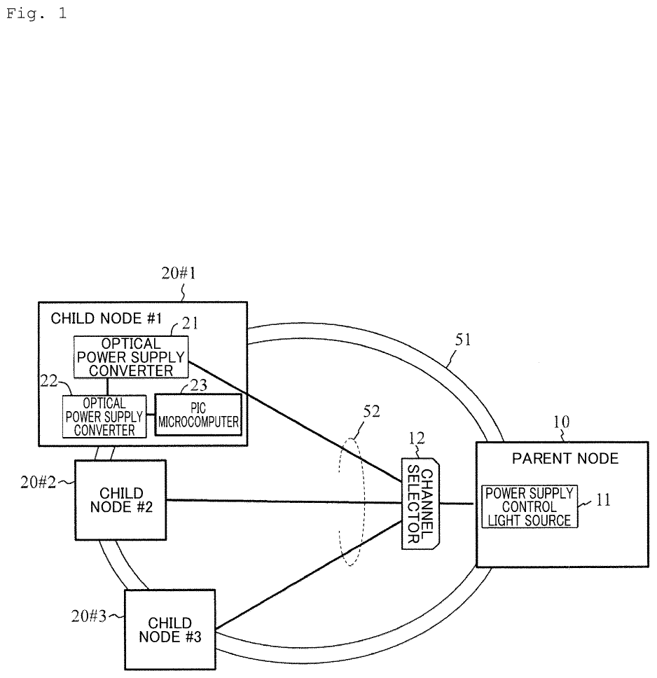

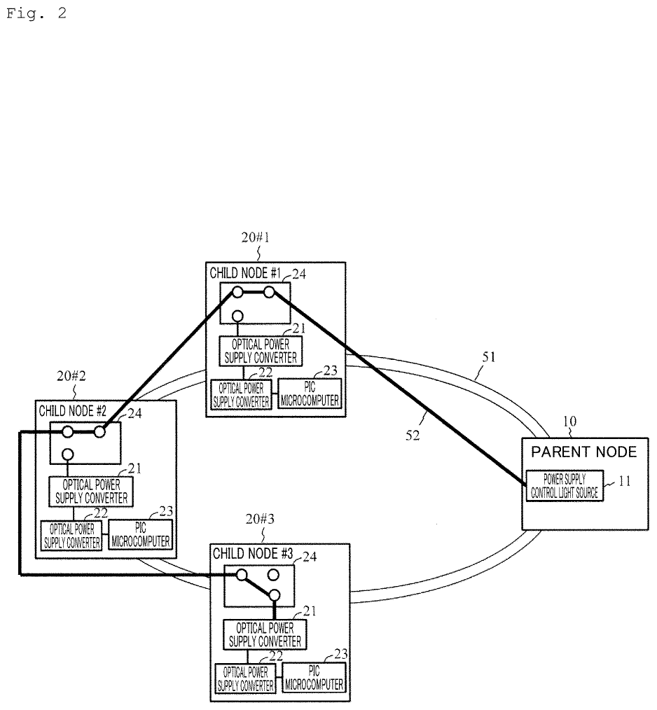

Each child node described in the embodiments below uses power stored in a power storage unit to drive a control unit and devices within the node. When each child node is not receiving optical power supply light, that is, when the channel selector 12 is switched in the direction of another child node in FIG. 1, or when each child node switches the 1×2 optical switch 24 to the rear child node side in FIG. 2, the power stored in the power storage unit 22 decreases over time due to driving of the PIC microcomputer 23, natural discharge, etc.

Further, optical power is supplied to the child node using an optical fiber 52 for power supply instead of an optical fiber 51 for a main signal.

### First Embodiment

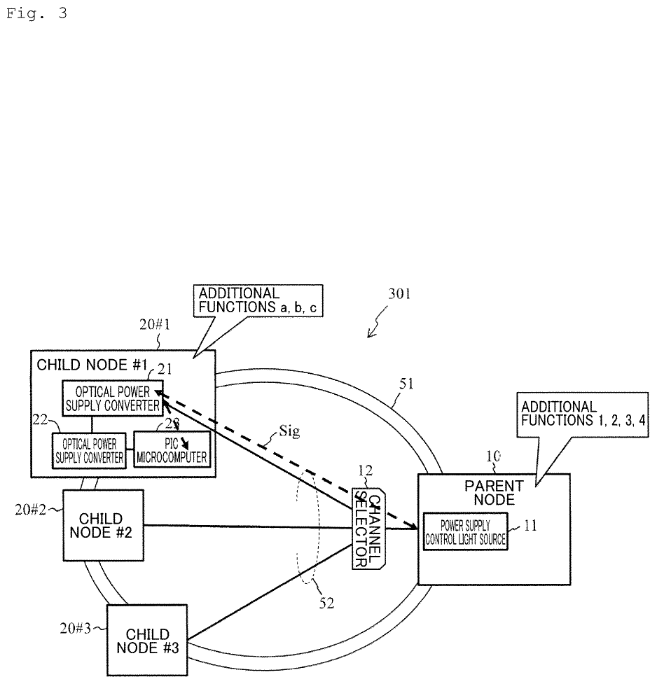

FIG. 3 is a diagram illustrating an optical communication system 301 of the present embodiment. The optical communication system 301 is an optical communication system in which one parent node 10 and one or more child nodes 20 are connected by an optical fiber 51 for a main signal and an optical fiber 52 for optical power supply, and light for driving power is supplied from the parent node 10 to the child nodes 20 through the optical fiber 52 for optical power supply, in which
the parent node 10 superimposes a signal on the light for driving power and transmits a reset signal and a reset completion confirmation signal to any one of the child nodes 20 through the optical fiber 52 for optical power supply, and the parent node 10 determines success or failure of resetting the child node 20 based on the presence or absence of a response signal transmitted from the child node 20 through the optical fiber 52 for optical power supply, and
the child node 20 receives the reset signal from the optical fiber 52 for optical power supply to reset itself, and after resetting itself and after receiving the reset completion confirmation signal, the child node 20 superimposes a signal on the light for driving power supplied from the parent node 10 to generate the response signal, and transmits the response signal to the parent node 10 through the optical fiber 52 for optical power supply.

In the present embodiment and the following embodiments, an example will be described in which superimposing a signal on light for driving power is achieved by intensity-modulating the light for driving power. Note that, superimposing a signal on the light for driving power may be achieved by another method, for example, a method of wavelength-multiplexing a signal of a different wavelength from that of the power supply light onto the light for driving power.

The following four functions are added to the parent node 10 of the optical communication system 301 compared to the parent node of the optical communication system described in FIG. 1.

(Additional function 1) A transmission function of transmitting a reset signal generated by modulating the power supply light from the parent node 10 to a specific child node 20.

(Additional function 2) A transmission function of transmitting a reset completion confirmation signal generated by modulating the power supply light from the parent node 10 to a specific child node 20.

(Additional function 3) A reception function of receiving a reset completion confirmation response signal generated by the child node 20 that has completed the reset by modulating the reflected light of the power supply light and transmitted to the parent node 10.

(Additional function 4) A determination function of determining success/failure of reset execution based on the presence or absence of reception of a response signal.

Note that, regarding the additional function 4, success/failure is determined based on, for example, whether or not a response signal indicating that the reset has been completed is received within a certain period of time after the transmission of the reset completion confirmation signal. Further, in FIG. 3, the reference numeral Sig indicates a reset signal, a reset completion confirmation signal, and a response signal transmitted and received between the parent node 10 and the child node 20.

The following three functions are added to the child node 20 of the optical communication system 301 compared to the child node of the optical communication system described in FIG. 1.

(Additional function a) A reception function of receiving a reset signal that is modulated power supply light from the parent node 10.

(Additional function b) An execution function of executing reset on the PIC microcomputer 23 after receiving a reset signal.

(Additional function c) A function of transmitting a response signal generated by modulating the reflected light of the power supply light to the parent node 20 after the reset is completed.

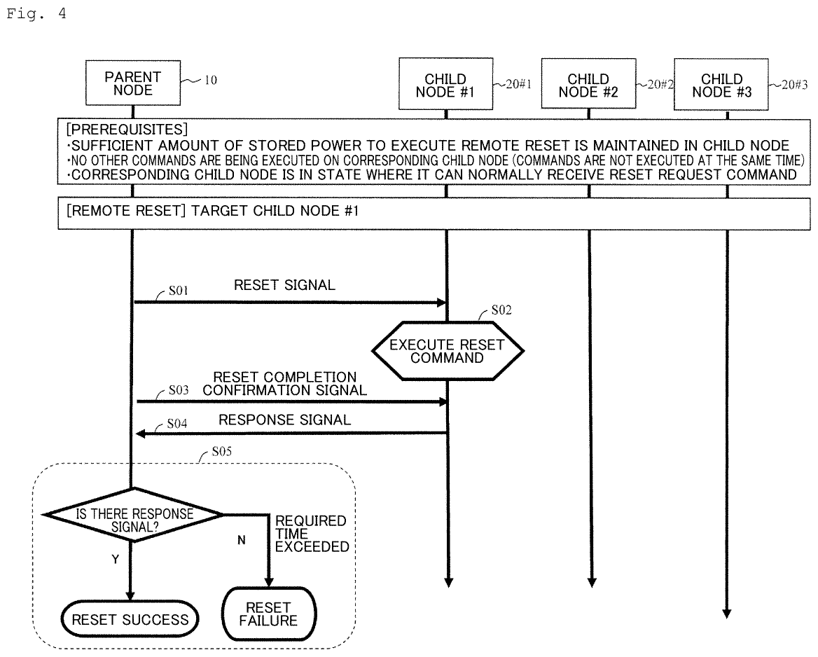

FIG. 4 is a sequence diagram illustrating a reset method for the child node 20 in the optical communication system 301. The prerequisites for this sequence are that a sufficient amount of stored power to execute the remote reset is maintained in the child node 20, that no other commands are being executed on the corresponding child node 20 (that is, a plurality of commands are not executed at the same time), and that the corresponding child node 20 is in a state where it can normally receive the reset request command.

This reset method is a reset method for resetting the child node 20 in the optical communication system 301, and includes: superimposing, by the parent node 10, a signal on the light for driving power and transmitting, by the parent node, a reset signal to any one of the child nodes 20 through the optical fiber 52 for optical power supply (step S01); receiving, by the child node 20, the reset signal from the optical fiber 52 for optical power supply to reset itself (step S02);
intensity-modulating, by the parent node 10, the light for driving power and transmitting, by the parent node 10, a reset completion confirmation signal to the child node 20 through the optical fiber 52 for optical power supply (step S03); superimposing, by the child node 20, after resetting itself and after receiving the reset completion confirmation signal, a signal on the light for driving power supplied from the parent node 10 to generate a response signal, and
transmitting, by the child node 20, the response signal to the parent node 10 through the optical fiber 52 for optical power supply (step S04); and
determining, by the parent node 10, success or failure of resetting the child node 20 based on the presence or absence of the response signal transmitted from the child node 20 through the optical fiber 52 for optical power supply (step S05).

In the present embodiment, a case will be described in which a child node 20#1 is remotely reset.

### Step S01

The parent node 10 drives the channel selector 12 or drives the 1×2 optical switch 24 for the child node 20#1, and sets an optical path to a state where optical power can be supplied to the child node 20#1. Then, the parent node 10 transmits a reset signal to the child node 20#1 using the additional function 1. The child node 20#1 receives the reset signal using the additional function a.

### Step S02

The child node 20#1 resets itself using the additional function b.

### Step S03

The parent node 10 transmits a reset completion confirmation signal to the child node 20#1 using the additional function 2.

### Step S04

When its own reset has been completed, the child node 20#1 transmits a response signal as a response to the reset completion confirmation signal using the additional function c.

### Step S05

The parent node 10 receives the response signal using the additional function 3. On the other hand, the parent node 10 may not be able to receive the response signal within a prescribed time from the transmission of the reset completion confirmation signal. Therefore, the parent node 10 determines whether the reset is successful or unsuccessful based on the presence or absence of reception of a response signal using the additional function 4.

With the functions and sequences described above, the child node 20 can be remotely restarted (remote reset) from the parent node 10, and furthermore, the parent node 10 can confirm whether the remote reset is successful or unsuccessful.

Although the present embodiment has been described using the parallel optical communication system shown in FIG. 1, remote reset can be similarly performed in the serial optical communication system shown in FIG. 2.

### Second Embodiment

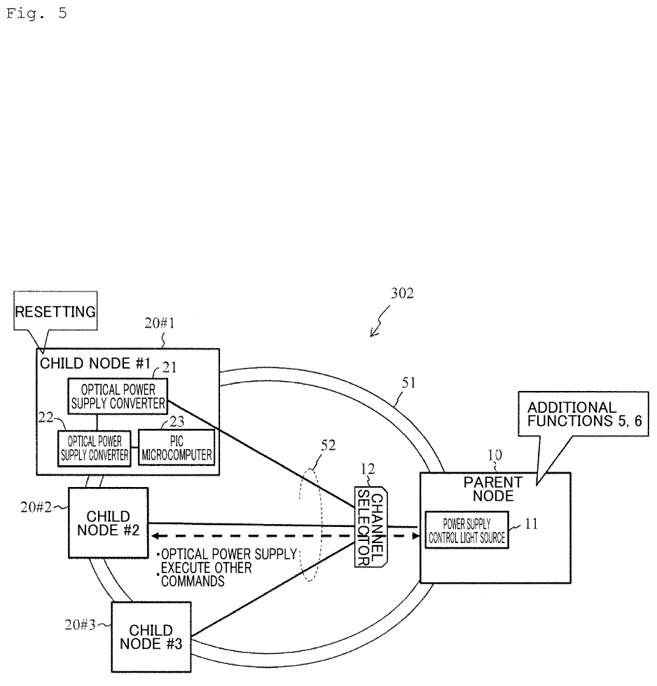

FIG. 5 is a diagram illustrating an optical communication system 302 of the present embodiment. In the optical communication system 302, compared to the optical communication system 301 shown in the FIG. 3, until the parent node 10 transmits the reset completion confirmation signal after transmitting the reset signal to any one of the child nodes 20 (for example, the child node 20#1), the light for driving power is supplied to any (for example, a child node 20#2) of the child nodes other than the corresponding child node.

Specifically, in the optical communication system 302, the following two functions are added to the parent node 10 of the optical communication system 301.

(Additional function 5) A function of ascertaining the time required to reset all child nodes 20.

(Additional function 6) A function for any child node to supply optical power to other child nodes or execute devices of the child node (switching connections of optical fiber core wire, etc.) during the reset execution period.

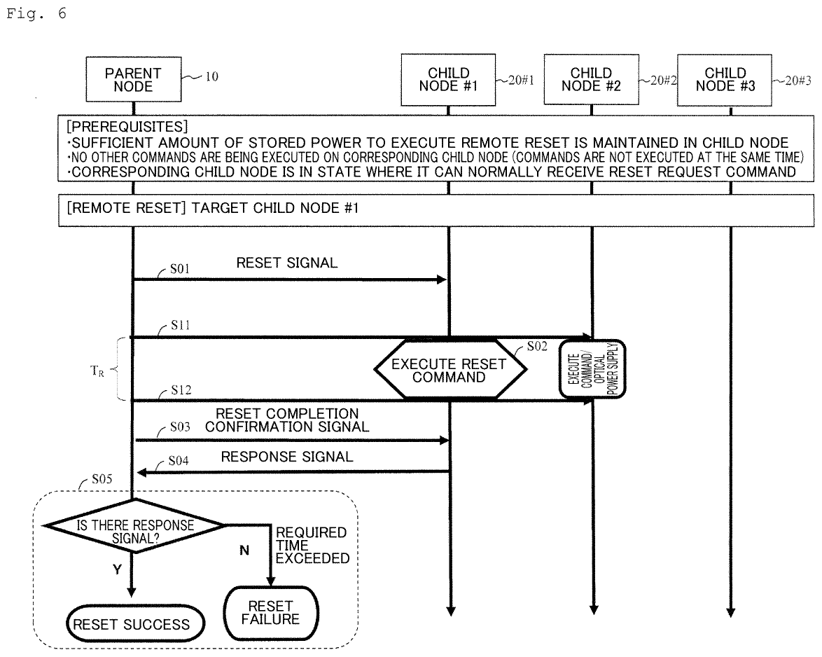

FIG. 6 is a sequence diagram illustrating a reset method for the child node 20 in the optical communication system 302. As in the first embodiment, a case will be described in which the child node 20#1 is remotely reset. In FIG. 6, only the parts that are different from the sequence in FIG. 4 will be described.

### Step S11

After step S01, the parent node 10 drives the channel selector 12 using the additional function 6, and switches the transmission destination of the optical power supply light to a child node (child node 20#2 in the present embodiment) other than the child node 20#1. Then, the parent node 10 supplies optical power or executes a command to the child node 20#2. During this time, step S02 is performed in the child node 10#1.

### Step S12

The parent node 10 drives the channel selector 12 and returns the transmission destination of the optical power supply light to the child node 20#1 after a time TR or more required for executing the reset, which is held in advance using the additional function 5, has elapsed.

Thereafter, step S03 and subsequent steps are performed for the child node 20#1.

With the functions and sequences described above, in the parallel optical communication system, while a child node 20 is executing a reset command, optical power can be supplied to other child nodes 20 or other commands can be executed.

Therefore, efficient operation of one power supply control light source 11 within the parent node 10 is possible.

### Third Embodiment

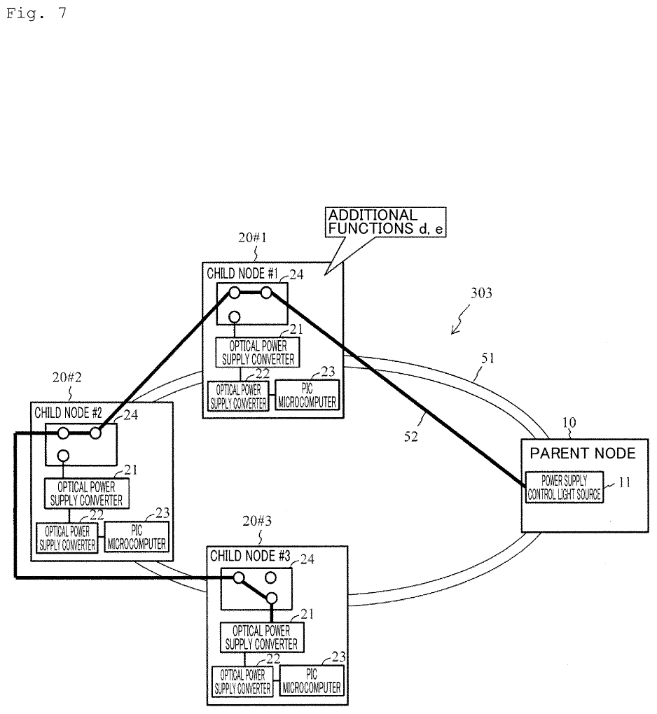

FIG. 7 is a diagram illustrating an optical communication system 303 of the present embodiment. In the optical communication system 303, the following two functions are added to the child node 20 of the optical communication system 303 compared to the child node of the optical communication system described in FIG. 2.

(Additional function d) A function in which the child node 20 (child node 20#1 in the present embodiment) that has received the reset signal autonomously switches its own 1×2 optical switch 24 to the rear side before starting reset.

(Additional function e) A function of switching the 1×2 optical switch 24 to its own side after the reset of the child node 20 is completed.

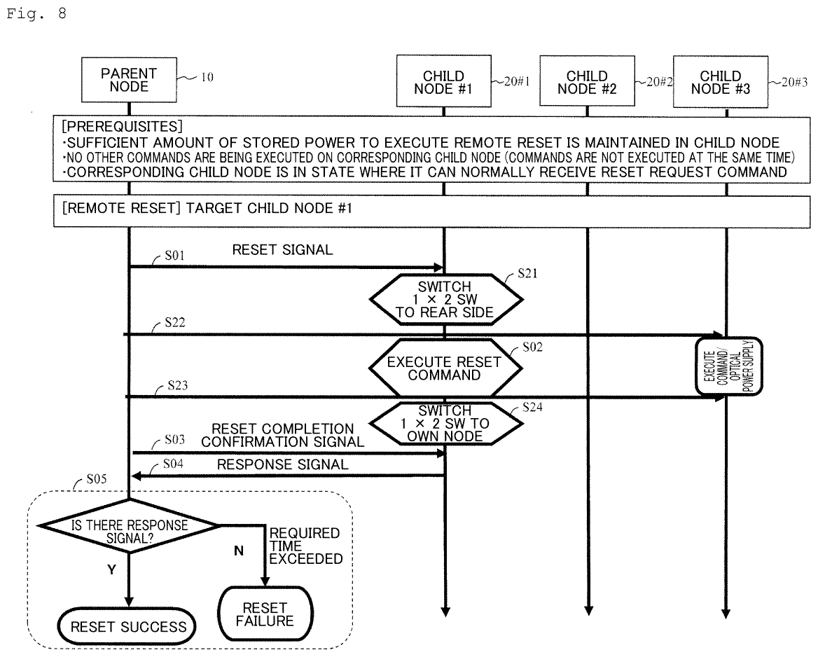

FIG. 8 is a sequence diagram illustrating a reset method for the child node 20 in the optical communication system 301. As in the first embodiment, a case will be described in which the child node 20#1 is remotely reset. In FIG. 8, only the parts that are different from the sequence in FIG. 4 will be described.

### Step S21

The child node 10#1 that has received the reset signal in step S01 autonomously switches its own 1×2 optical switch 24 to the rear side.

### Step S22

While the reset command is being executed by the child node 10#1, the parent node 10 switches the transmission destination of the optical power supply light to a child node (child node 20#3 in the present embodiment) other than the child node 20#1. Then, the parent node 10 supplies optical power or executes a command to the child node 20#3.

During this time, step S02 is performed in the child node 10#1.

### Step S23

The parent node 10 returns the transmission destination of the optical power supply light from the child node 20#3 to the child node 20#1 after the time TR or more required for executing the reset, which is held in advance using the additional function 5, has elapsed (end of optical power supply/command execution).

### Step S24

After the execution of the reset command in step S02 is completed, the child node 20#1 switches its own 1×2 optical switch 24 to its own side.

Thereafter, step S03 and subsequent steps are performed for the child node 20#1.

With the functions and sequences described above, in the serial optical communication system, while a child node 20 is executing a reset command, optical power can be supplied to other child nodes 20 or other commands can be executed.

Therefore, efficient operation of one power supply control light source 11 within the parent node 10 is possible.

### Fourth Embodiment

In the first to third embodiments, when the parent node 10 cannot receive a response signal from the child node 20 in step S05 (when the reset fails), steps S01 to S05 are automatically repeated for the child node 20 for which the reset failed. This repetition is preferably repeated up to a certain number of times (N times) until the parent node 10 can receive the response signal.

### Fifth Embodiment

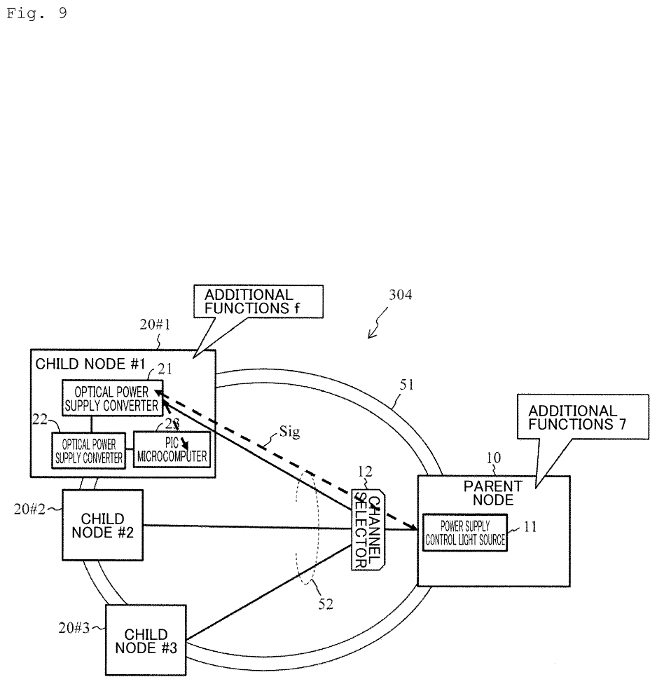

FIG. 9 is a diagram illustrating an operation of an optical communication system 304 of the present embodiment. In the optical communication system of the present embodiment, the following functions are added to the optical communication systems (301 to 303) of the first to third embodiments.

(Additional function f) This is a function that is added to the child node 20, and is a function of sending back the reset start time and completion time together when sending a response signal after the reset is completed.

(Additional function 7) This is a function that is added to the parent node 10, and is a function of managing the data of the number or identifier (eg, child node #1) of the child node 10 included in the response signal from the child node 20, the reset start time, and the reset completion time.

With the functions described above, the parent node 10 of the optical communication system of the present embodiment can calculate the time required for resetting each child node 20 from the reset start time and completion time. In other words, it is possible to avoid sending the reset completion confirmation signal in step S03 during resetting (resetting is repeated because a response signal cannot be transmitted from the child node) or after a while after the reset is completed (no movement time occurs), and it is possible to improve the operation of the optical communication system.

### Reference Signs List

10 Parent node
11 Power supply control light source
12 Channel selector
20, 20#1, 20#2, 20#3 Child node
21 Optical power supply converter
22 Power storage unit
23 PIC microcomputer
24 Optical switch
51 Optical fiber for main signal
52 Optical fiber for optical power supply
301 to 304 Optical communication system

1. An optical communication system in which one parent node and one or more child nodes are connected by an optical fiber for a main signal and an optical fiber for optical power supply, and light for driving power is supplied from the parent node to the child node through the optical fiber for optical power supply, wherein the parent node superimposes a signal on the light for driving power and transmits a reset signal and a reset completion confirmation signal to any one of the child nodes through the optical fiber for optical power supply, and the parent node determines success or failure of resetting the child node based on presence or absence of a response signal transmitted from the child node through the optical fiber for optical power supply, and the child node receives the reset signal from the optical fiber for optical power supply to reset the child node itself, and after resetting the child node itself and after receiving the reset completion confirmation signal, the child node superimposes a signal on the light for driving power supplied from the parent node to generate the response signal, and transmits the response signal to the parent node through the optical fiber for optical power supply.

2. The optical communication system according to claim 1, wherein, until the parent node transmits the reset completion confirmation signal after transmitting the reset signal to any one of the child nodes, the light for driving power is supplied to any of the child nodes other than the corresponding child node.

3. The optical communication system according to claim 1, wherein the parent node transmits the reset signal and the reset completion confirmation signal a prescribed number of times when the response signal is not received after transmitting the reset completion confirmation signal.

4. The optical communication system according to claim 1, wherein the child node includes, in the response signal, a start time at which the reset is started and a completion time at which the reset is completed, and the parent node extracts the start time and the completion time from the response signal, and manages the start time and the completion time for each child node.

5. A reset method for resetting a child node in an optical communication system in which one parent node and one or more child nodes are connected by an optical fiber for a main signal and an optical fiber for optical power supply, and light for driving power is supplied from the parent node to the child node through the optical fiber for optical power supply, the reset method comprising:
superimposing, by the parent node, a signal on the light for driving power and transmitting, by the parent node, a reset signal to any one of the child nodes through the optical fiber for optical power supply;
receiving, by the child node, the reset signal from the optical fiber for optical power supply to reset the child node itself;
transmitting, by the parent node, a reset completion confirmation signal through the optical fiber for optical power supply;
superimposing, by the child node, after resetting the child node itself and after receiving the reset completion confirmation signal, a signal on the light for driving power supplied from the parent node to generate a response signal, and transmitting, by the child node, the response signal to the parent node through the optical fiber for optical power supply; and
determining, by the parent node, success or failure of resetting the child node based on presence or absence of the response signal transmitted from the child node through the optical fiber for optical power supply.

6. The reset method according to claim 5, further comprising:
supplying, until the parent node transmits the reset completion confirmation signal after transmitting the reset signal to any one of the child nodes, the light for driving power to any of the child nodes other than the corresponding child node.

7. The reset method according to claim 5, further comprising:
transmitting, by the parent node, the reset signal and the reset completion confirmation signal a prescribed number of times when the response signal is not received after transmitting the reset completion confirmation signal.

8. The reset method according to claim 5, further comprising:
including, by the child node, in the response signal, a start time at which the reset is started and a completion time at which the reset is completed; and
extracting, by the parent node, the start time and the completion time from the response signal, and managing, by the parent node, the start time and the completion time for each child node.
